(19) United States
(12) Patent Application Publication
(10) Pub. No.: US 2006/0059559 A1
(43) Pub. Date: Mar. 16, 2006

(54) Flexible multi-channel systems utilizing removable/portable subscription processing

(76) Inventor: William E. Dyson, Carmel, IN (US)

Correspondence Address: DELPHI TECHNOLOGIES, INC., M/C 480-410-202, PO BOX 5052, TROY, MI, 48007, US

(21) Appl. No.: 10/927,887

(22) Filed: Aug. 27, 2004

(51) Int. Cl. H04N 7/16

(52) U.S. Cl. 726/26

(57) ABSTRACT

The present invention provides a flexible multi-channel system comprising at least one receiver capable of providing simultaneous output of multiple channels, each requiring exchange of security information to identify and control its subscription level, from a single received signal source. Each receiver has a base circuit and a plurality of portable circuits adapted to detachably interface with the base circuit. The base circuit is defined within a base unit of the receiver, and each of portable circuits is defined within a portable device operably connectable to the base unit.

### TECHNICAL BACKGROUND

1. Field of the Invention

The present invention relates to audio and/or video systems, particularly receivers for subscription based systems.

2. Description of the Related Art

Current subscription based audio and/or video receiver systems (Satellite TV, Satellite Radio, etc.) utilize some form of subscriber identification method to identify a particular receiver with a specific customer and to control the subscription level of that receiver. Such methods typically require the exchange of security information between two or more devices within the subject receiver. Information exchange may include, but is not limited to, an Electronic Serial Number (ESN), keys to enable decryption of the received signal, and details of the current subscription level of the receiver. Although in some cases some portion of this method may be removable from a receiver, such as Direct TV's use of SmartCards, this method prevents interchangeability across more than one receiver.

Such subscription based audio and/or video services typically broadcast an RF signal within a specified frequency range. Broadcast methods may include, but are not limited to, one or more of satellite, terrestrial antennas, and cable. The RF signal generally comprises a plurality of channels of information (audio, video, data, etc.) of interest to the consumer. Typical receivers are designed to receive an RF signal and process it to provide an output, in appropriate form, of the data of one of the available plurality of channels.

A system capable of providing output from multiple channels simultaneously requires either multiple receivers, or duplication of some or all of the receiver circuitry for each additional channel desired. Each additional channel also requires its own subscription identification and control. When multi-channel capability is desired in multiple locations, in home and in car, for example, moving complete receivers or providing multiple receivers in each location is required. Moving complete receivers may not necessarily be feasible when a given receiver's design is not compatible with the multiple locations. Providing multiple receivers may be costly and cumbersome.

### SUMMARY OF THE INVENTION

The present invention provides a flexible multi-channel system comprising at least one receiver capable of providing simultaneous output of multiple channels, with each output requiring exchange of security information to identify and control its subscription level, from a single received signal source. Each receiver has a base circuit and a plurality of portable circuits configured for interfacing with the base circuit. The base circuit is defined within a base unit of the receiver, and each of portable circuits is defined within a portable device operably connectable to the base unit.

The base unit may define a plurality of ports. Each port enables an interface between the base circuit and one of the plurality of portable circuits. One or more portable device may interface with a single base unit, enabling output of multiple channels from a single receiver.

Each base unit may be disposed at one of a plurality of locations. Each portable device may be moved from one base unit in one location to another base unit in another location. One of the portable circuits may be optionally defined in a fixed device connected to the base unit.

Each portable device comprises a subscription control having security information specific to its output. The security information may include electronic security number (ESN), subscription level, decryption key, or any combination thereof. The portable device also comprises a digital processor or a microprocessor. The processor, interfacing with the subscription control, is capable of processing a digital input signal by performing at least one of the functions including demodulation, selection of sources (selecting one of the plurality of available channels), decryption, decompression, and subsequently producing a digital output, typically, but not required to be, serial.

The base unit comprises a tuner operably connected to an antenna for selecting a frequency range of RF signals received by the antenna. The tuner is capable of down converting a selected RF signal to Intermediate Frequency (IF).

An analog-to-digital converter (ADC) is provided within either the base circuit or the portable circuit, and is electronically communicated with the tuner for sampling the IF signal to produce a digital input signal that is processed by the processor.

Further, a digital-to-analog converter (DAC) may be provided within either the base circuit or the portable circuit. The DAC is electronically communicated with the processor for converting the digital output produced by the processor to an analog audio output.

Alternatively, the flexible multi-channel system of the present invention may replace the DAC with some other audio or video device operably connected to the receiver for producing an audio or a video output from the digital output.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a block diagram showing a receiver of prior art;

FIG. 2 is a block diagram showing another receiver of prior art;

FIG. 3 is a block diagram showing circuit partitioning of a receiver according to one embodiment of the present invention;

FIG. 4 is a block diagram showing circuit partitioning of a receiver according to another embodiment of the present invention;

FIG. 5 is a block diagram showing circuit partitioning of a receiver according to an alternative embodiment of the present invention;

FIG. 6 is a block diagram showing a flexible system according to one embodiment of the present invention;

FIG. 7 is a block program showing a multi-channel system according to another embodiment of the present invention;

FIG. 8 is a block diagram showing a multi-channel system according to an alternative embodiment of the present invention;

FIG. 9 is a flow chart showing the process of conversion of the signal within a receiver of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

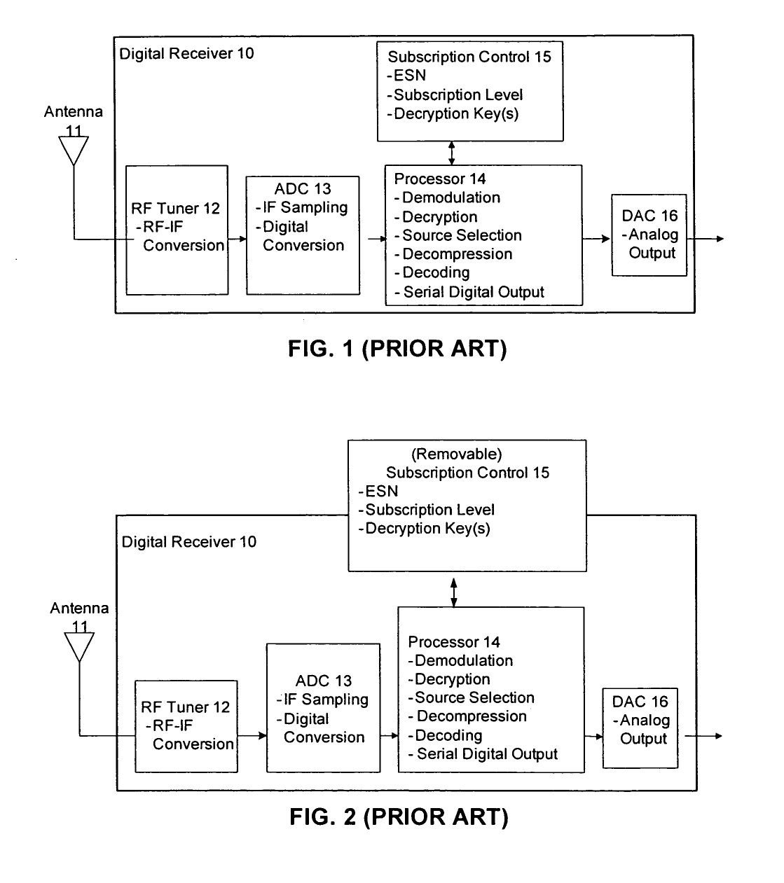

A digital receiver of prior art may be illustrated by the block diagram shown in FIG. 1. As shown, digital receiver 10 is capable of receiving one or more Radio Frequency (RF) signals from at least one antenna 11. Digital receiver 10 includes RF tuner 12 for facilitating the selection of specific RF ranges, and down converting of the input RF frequency directly to a usable Intermediate Frequency (IF) for digital sampling. Digital receiver 10 includes analog-to-digital converter (ADC) 13, which converts the analog input signal to a digital signal by sampling at the desired digital processing rate. Digital processor 14 is included within digital receiver 10 for providing numerous functions including demodulation, decoding, and decryption of the digitized signal before creating a digital output stream. This digital stream may be converted to an analog audio output by digital-to-analog converter (DAC) 16, or may be used for processing by downstream processing such as audio amplification or video processor (not shown). Digital processor 14 may also interface with the subscription control 15. This interface provides the digital receiver identification and control of the subscription level selected by the user. The interface may further provide the necessary secure keys to decrypt supplier-protected content received by the receiver.

In FIG. 2, digital receiver 10 represents another typical receiver. Digital receiver 10 includes subscription control 15 that is removable and processor 14 that is fixed within digital receiver 10. However, subscription control 15 in digital receiver 10 is not portable from one digital receiver to another due to the required exchange of secure information between subscription control 15 and digital processor 14. This lack of portability makes the use of digital receiver 10 in multiple locations inconvenient or impossible because the movement from one location to another of the entire receiver would be required.

The present invention provides flexible and multi-channel systems having one or more receiver capable of receiving and processing multiple outputs from a plurality of available channels. The systems may include audio or video devices for producing audio or video output. The receiver of the present invention is a digital receiver developed based on appropriate partitioning of the receiver's functions into a base circuit and a portable circuit. The base circuit and the portable circuit are constructed according to any method known in the art.

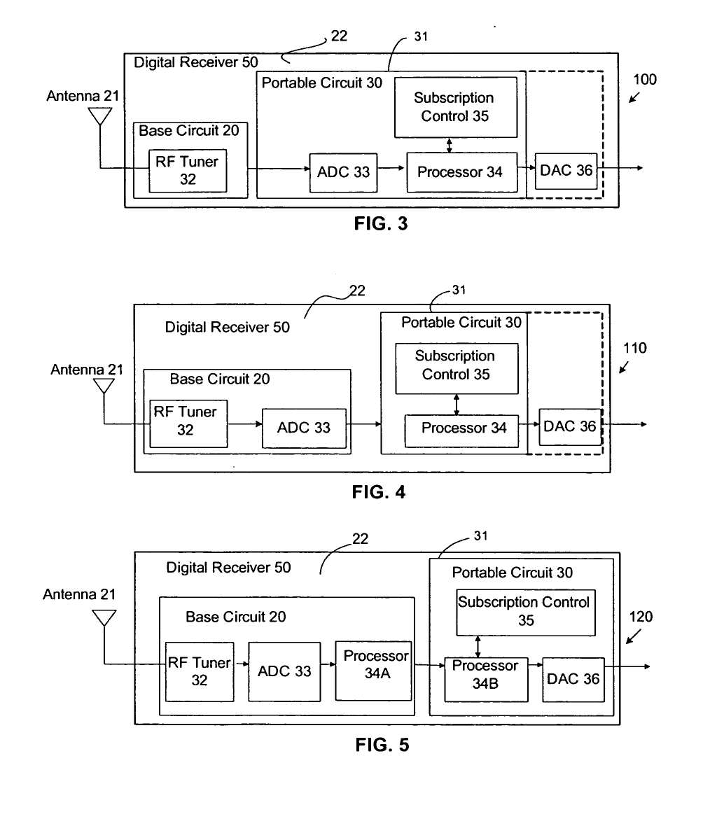

In one embodiment of the present invention, as represented in the block diagram in FIG. 3, system 100 has digital receiver 50 partitioned into base circuit 20 and portable circuit 30. Base circuit 20 is localized within base unit 22 and portable circuit 30 may be defined within portable device 31. Base unit 22 includes tuner 32, which is operably connected to antenna 21 capable of receiving the RF signals. As shown, portable circuit 30 or portable device 31 includes ADC 33, subscription control 35, and processor 34. In addition, DAC 36 may also be provided within base unit 22 or portable unit 31 of receiver 50. Alternatively, a DAC may be provided in a separate device connectable to receiver 50.

In another embodiment, as represented in the block diagram in FIG. 4, system 110, like system 100, also has digital receiver 50 partitioned into base circuit 20 and portable circuit 30. Like in system 100, base circuit 20 is defined within base unit 22 and portable circuit 30 is defined within portable device 31. In this embodiment, base unit 22 includes tuner 32 operably connected to antenna 21 and ADC 33, while portable device 31 includes subscription control 35 and processor 34. Again, DAC 36 may be provided within base unit 22 or portable device 31.

In an alternative embodiment, as represented in FIG. 5, system 120 also includes receiver 50 that is partitioned into base circuit 20 defined within base unit 22, and portable circuit 30 defined within portable device 31. In this embodiment, base unit 22 includes, in addition to tuner 32 operably connected to antenna 21, ADC 33 and processor 34A. Portable circuit 30 or portable device 31 includes subscription control 35 and processor 34B. Processor 34A and 34B may perform separate functions. For example, processor 34A may be capable of demodulation, source selection (selecting one of the plurality of available channels), and decoding, while processor 34 B may be capable of decryption, decompression, and production of digital output. As further illustrated in FIG. 5, DAC 36 may be included in portable device 31. However, DAC 36 may be disposed within base unit 22, as shown in FIGS. 3-4.

It is to be understood that components included with base unit 22 are electronically connected to one another within base circuit 20, and components included with portable device 31 are electronically connected to one another within portable circuit 30. For examples, in FIG. 3, ADC 33, subscription control 35, and processor 34 are connected to one another within portable circuit 30, and in FIG. 4, tuner 32 is connected to ADC 33 within base circuit 20, while subscription control 35 is connected to processor 34 in portable circuit 30.

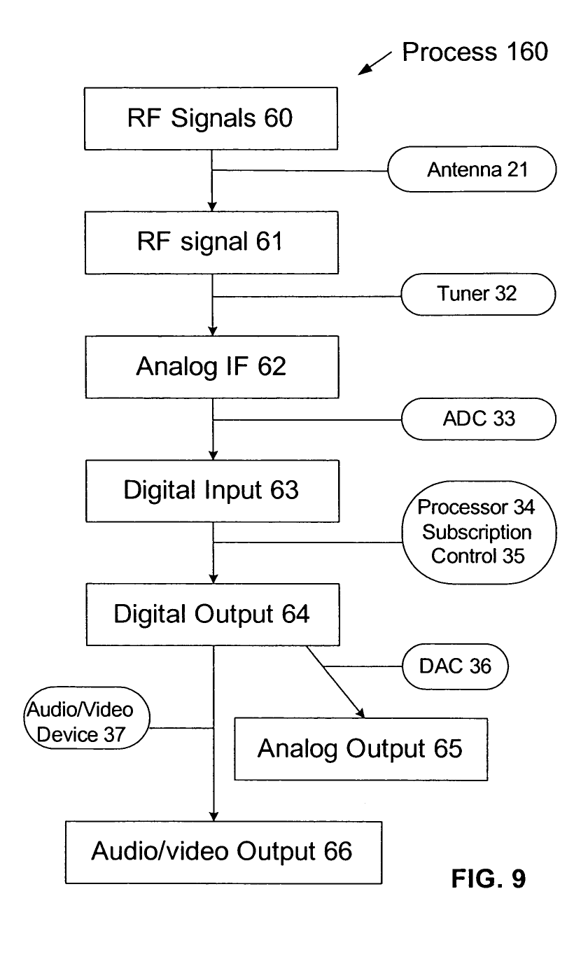

In FIG. 9, a flow chart demonstrates the process 160 of signal conversion by the receiver of the present invention. As shown, RF signals 60 carrying digitally encoded audio/video entertainment may be broadcast directly from an orbiting satellite, and/or via a repeater (terrestrial antenna) network. RF signals 60 may be captured by antenna 21, which may represent one or more antennas configured to receive RF signals 60. Tuner 32 facilitates the selection of RF signal 61 based on the specific range of the RF. Tuner 32 may down convert RF 61 to analog IF 62. ADC 33 is responsible for sampling IF 62 and convert to digital IF signal 63 (digital input signal). Subscription control 35 contains security information such as ESN, subscription level, and decryption key(s) related to outputting one of the plurality of available channels. Processor 34 may decode the security information from subscription control 35 and perform other functions including demodulation, source selection, decryption, decompression, and subsequently produces a digital output 64 from the digital input signal 63 produced by ADC 33. DAC 36 is responsible for converting digital output stream 64 to usable analog output 65, which usually is an audio output. Alternatively, an output device such as audio/video device 37 may be provided for converting digital output 64 to output 66. Audio/video device 37 may include an audio or video amplifier and speakers, a TV or display screen or a computer screen. It is contemplated that output 66 may include audio, video, or any other data such as text information, i.e., stock quotes and sport scores. In addition, output 66 may also include data to update databases such as those used in a navigation system.

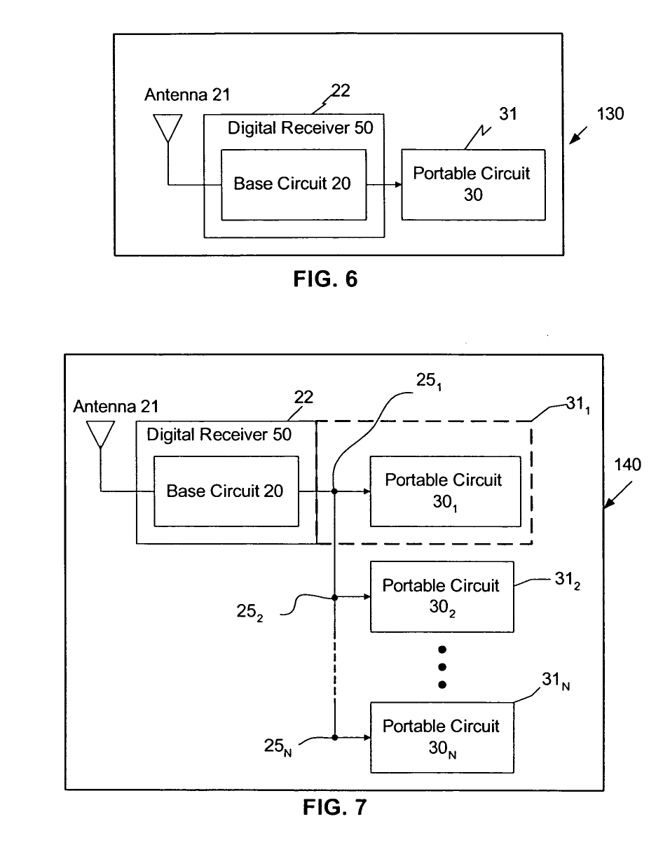

It is to be understood that, regardless of how the circuit of receiver 50 is partitioned, receiver 50 should comprise base circuit 20, and portable circuit 30 interfacable to one another, as in system 130 represented in the block diagram in FIG. 6. As described above, base circuit 20 may be defined in base unit 22 of receiver 50, and portable circuit 30 may be defined in portable device 31. Portable device 31 may be in a form of a chip card or a smart card (or other similar form factor) containing not only the subscription control, but the processor, as described above (see FIGS. 3-5). Further, portable device 31 may include information relating to other personal information or source information, such as name of the user or a credit card number, as commonly found in a typical smart card.

Furthermore, the system of the present invention may be designed with an expandable receiver, as represented in FIG. 7. As shown, system 140 comprises receiver 50 having base circuit 20 disposed in base unit 22. Base unit 22 may define one or more ports 25₁to 25_{N} (N is an integer) for connecting with a plurality of portable circuits 30₁ to 30_{N}. Portable circuits 30₁ to 30_{N} are disposed within device 31₁ to 31_{N}, respectively. As demonstrated, device 31₁ may be portable or fixedly connected to base unit 22, while devices 31₂ to 31_{N} may be portable. Each of devices 31₁ to 31_{N} contains subscription control specific to its output. A user may choose either one or a combination of devices 31₁ to 31_{N} for interfacing with base circuit 20 for outputting content from one or more channels.

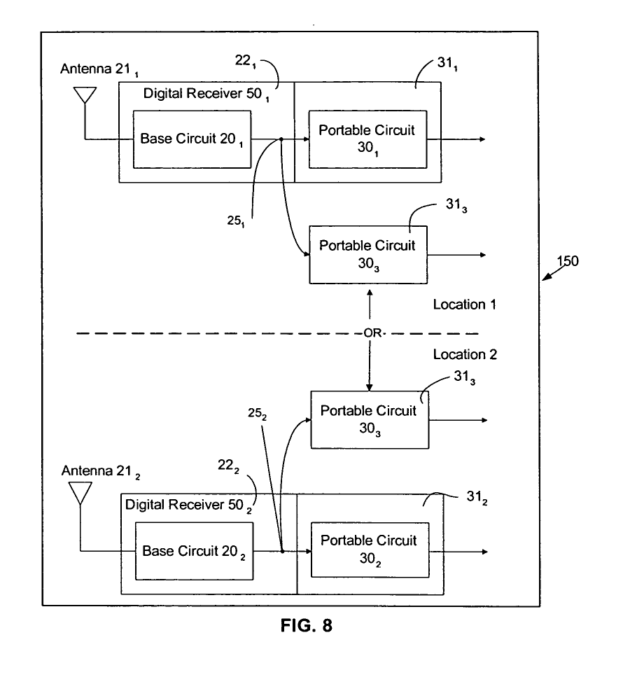

In an alternative embodiment as represented in FIG. 8, system 150 includes receiver 50₁ disposed at location 1, and receiver 50₂ disposed at location 2. Locations 1-2 may represent any applications or actual locations. For example, location 1 may represent a satellite radio in a vehicle, and location 2 may represent a home surround sound system. As shown, receiver 50₁ includes base circuit 20₁ defined within base unit 22₁, and portable circuit 30₁ defined in device 31₁. Receiver 50₂ includes base circuit 20₂ defined within base unit 22₂, and portable circuit 30₂ defined in device 31₂. Devices 31₁ and 31₂ may be portable or fixedly connected to base units 22₁ and 22₂, respectively. Additional portable circuit 30₃ disposed in portable device 31₃ is also provided. Portable device 31₃ may be moved to receiver 50₁ or 50₂, and connected to port 25₁ or 25₂ such that portable circuit 30₃ may interface with base circuit 20₁ or 20₂, respectively. With this embodiment, the user has a choice between channels specified in either device 31₁ or device 31₃ with receiver 50₁, and between channels specified in either device 31₂ or device 31₃ with receiver 50₂.

Since portable circuits of the present invention are portable between several receivers in multiple locations, the present invention provides the flexibility, for example, of multi-channel entertainment to move with the user from one location to another in a convenient fashion.

While the present invention has been described as having exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A signal receiving system comprising:
a receiver comprising:
a base circuit adapted to receive a signal comprising a plurality of channels, and
a portable circuit adapted to detachably interface with the base circuit, each portable circuit comprising:
a subscription control having security information specific to the portable circuit, and
a processor operably connected to the subscription control, the subscription control enabling the processor to process the received signal according to the security information, select one of the plurality of channels, and produce a digital output.

2. The system of claim 1, wherein the base circuit comprises:
at least one antenna for receiving Radio Frequency (RF) signals; and
a tuner operably connected to the at least one antenna for selecting a frequency range of the RF signals.

3. The system of claim 2, wherein the tuner is capable of down converting a selected RF signal to an analog Intermediate Frequency (IF).

4. The system of claim 3, wherein the receiver further comprises:
an analog-to-digital converter (ADC) electronically communicated with the tuner for converting the analog IF to a digital input signal, the ADC disposed within either the base circuit or the portable circuit.

5. The system of claim 1, wherein the security information comprises: an electronic security number (ESN), a subscription level, a decryption key, or a combination thereof.

6. The system of claim 1, wherein the processor is capable of performing: demodulation, selection of sources, decoding, decryption, decompression, or a combination thereof.

7. The system of claim 1, wherein the base circuit includes a partial processing capability.

8. The system of claim 7, wherein the partial processing capability includes demodulation, selection of sources, and decoding, and wherein the processor is capable of decryption, decompression, and producing the digital output.

9. The system of claim 1, wherein the receiver further comprises:
a digital-to-analog converter (DAC) electronically communicated with the processor for converting the digital output produced by the processor to an analog output.

10. The system of claim 9, wherein the DAC is disposed within either the base circuit or the portable circuit.

11. The system of claim 10, wherein the DAC is operably connected to an audio device.

12. The system of claim 1 further comprises an output device operably connected to the receiver for playing or displaying an audio or video or text output.

13. The system of claim 1, wherein the base circuit is adapted to interface with a plurality of portable circuits, enabling the receiver to receive and process the received signal to provide a plurality of outputs from amongst the channels available within the received signal.

14. The system of claim 13, wherein the base circuit is defined within a base unit of the receiver, and each of portable circuits is defined within a portable device operably connectable to and detachable from the base unit.

15. The system of claim 14, wherein one of the plurality of portable circuit is defined within a fixed device connected to the base unit.

16. The system of claim 14, wherein the base unit defines a plurality of ports, each of the plurality of ports enabling a connection between the base unit and one of the portable devices.

17. The system of claim 13 further comprises a plurality of output devices operably connected to the receiver for playing or displaying audio or video or data output.

18. A signal receiving system comprising:
a portable circuit adapted to detachably interface with a base circuit of a receiver, each portable circuit comprising:
a subscription control having security information specific to the portable circuit, and
a processor operably connected to the subscription control, the subscription control enabling the processor to process a received signal according to the security information, select one of the plurality of channels, and to produce a digital output.

19. The system of claim 18, wherein the security information comprises: an electronic security number (ESN), a subscription level, a decryption key, or a combination thereof.

20. The system of claim 18, wherein the processor is capable of performing: demodulation, selection of sources, decoding, decryption, decompression, or a combination thereof.

21. The system of claim 18, wherein the portable circuit further comprises at least one of:
an analog-to-digital converter (ADC) operably connected to the processor and adapted for converting an analog input signal to a digital input signal to be processed by the processor, and
a digital-to-analog converter (DAC) operably connected to the digital processor for converting the digital output to an analog audio output.

22. A signal receiving system comprising:
a receiver comprising:
a base circuit adapted to receive a signal comprising a plurality of channels, and
a plurality of portable circuits adapted to detachably interface with the base circuit, each portable circuit comprising:
a subscription control having security information specific to the portable circuit, and
a processor operably connected to the subscription control, the subscription control enabling the processor to process the received signal according to the security information, select one of the plurality of channels, and produce a digital output; and
a plurality of output devices, each operably connected to the receiver for playing or displaying the output.
